(19) United States
(12) Patent Application Publication
(10) Pub. No.: US 2005/0220354 A1
(43) Pub. Date: Oct. 6, 2005

(54) Temporal noise reduction and local contrast amplification

(76) Inventor: Markus Simon, Munchen (DE)

Correspondence Address: Bell Boyd & Lloyd;Three First National Plaza, Suite 3300, 70 West Madison Street, Chicago, IL, 60602-4207, US

(21) Appl. No.: 10/496,211

(22) PCT Filed: Nov. 19, 2001
(86) PCT No.: PCT/DE01/04341

§ 371 Date: May 19, 2004

(51) Int. Cl. G06K 9/40

(52) U.S. Cl. 382/254; 382/274

(57) ABSTRACT

The present invention relates to a method for processing images, wherein images scanned by at least one detector device are processed, and to a device for carrying out the method. According to the present invention, an image is produced from a sequence of chronologically successive individual images by temporal averaging of when individual images. During a classification step of the method, structured image areas are identified in an image and high pass filtering occurs in another step of the method in the identified structured image areas of the resulting image. Temporal averaging enables detector noise to be reduced and subsequent high pass filtering, which is previously and selectively limited to structurally recognized images, increases the resolution virtually, thereby enhancing the overall image quality.

### BACKGROUND OF THE INVENTION

The present invention relates to a method for processing images, whereby images scanned by at least one detector device are processed, and further relates to a device for carrying out the method together with a computer program product.

In the case of video-recorders, such as video cameras, there are known ways to filter the images detected by the video-recorder's image sensor. In the case of sequences of images, movement compensation is first applied, provided that there are only small displacements between each of the successive images in a sequence, caused by the shaking movements of the person holding the video-recorder to operate it. Normally, all the image data or image array elements for an image are then subject to high-pass filtering, so that low-frequency interference or interfering pulses are largely suppressed. However, as these conventional filtering methods are used in high-quality devices with detectors which only have low detector noise levels, it is unsatisfactory with this prior art that, when use is made of relatively cheap image detectors, such as are frequently used in mobile terminal devices with supplementary video functions and which, by comparison with high-quality video-recorders, have a lower image resolution and a relatively high noise level, this conventional filtering method does not result in the suppression or reduction of the noise. In particular, this is true in areas of the image with little structure, in which relatively uniform or homogeneous gray and color transitions, such as occur in monotonous blue areas of sky in an image, any detector noise present is distinctly perceptible, and hence is detrimental to the image quality.

There is therefore a need to produce a method of the type described above, and a device for carrying out this method, together with a computer program product, by which the detector noise is reduced and the image quality raised for sequences of images which have been detected.

### SUMMARY OF THE INVENTION

This object is achieved, in terms of the method, in that temporal averaging is used to produce a resultant image from a sequence of temporally consecutive individual images, in that, during a classificatory step of the method, structured areas are identified in the image and, in a subsequent method step, high-pass filtering is applied in the structured areas which have been identified in the resultant image.

As a result, it is a characteristic of the method in accordance with the present invention that, unlike the prior art, by which each entire image undergoes high-pass filtering, the high-pass filtering covers selected areas of an image which have been identified beforehand, in a classificatory method step, as structured areas. Before the classificatory method step is performed, the images which belong to a sequence are used to generate a temporally averaged image, in which the detector noise is significantly reduced as a result of the temporal averaging. Before doing this, the number of images included in a sequence is determined. Since the low image resolution of cheap detectors is most clearly perceptible in strongly structured areas of an image, due to the limited resolution and the coarse sampling this implies, with the high-pass filtering of the method in accordance with the present invention, which is selectively restricted to the structured areas of the image, there is a virtual increase in the resolution and, accordingly, an improvement in the image quality. Hence, the method in accordance with the present invention can be used both in video-camera devices which have a high detector performance and in devices which have detectors with a lower detector performance, such as so-called video-mobiles. An example of a suitable application area is the sampling (“scanning”) of texts, where there is an abrupt change in brightness between the text and the background.

In accordance with one embodiment of the method in accordance with the present invention, the intensities associated with image array elements which have corresponding location coordinates in each of the temporally successive individual images of a sequence are summed, and the sum thus formed is divided by the number of individual images in the sequence. In this way, a temporally averaged intensity is assigned to each image array element or image pixel in the image array of the resultant image. This reduces the detector noise levels in proportion to the number of images in each sequence on which the temporal averaging is based, where the resulting improvement in the image quality is most clearly demonstrable in unstructured areas of the image, containing practically homogeneous gray or color values.

An embodiment of the method in accordance with the present invention may include successive calculation of local changes in the intensity between image array elements which are in neighboring locations, as determined in each case by their position coordinates, for the purpose of identifying the structured image areas in an image, and if a local change reaches or exceeds a predefined threshold parameter, the image array elements which underlie this change are assigned to a structured image area. On the other hand, for a local change in the intensity which falls below the predefined threshold parameter, the image data which underlies the change concerned is assigned to a low-structure area. For the purpose of determining each of the local changes in intensity, local gradients are calculated in each case, with each calculated local gradient being given a normalized value.

In the method step which then follows, a second order high-pass filter is used for the high-pass filtering. A preferred embodiment of the present invention includes the high-pass filter taking the form of a Laplace operator, whereby the Laplace operator forms a second derivative with respect to location variables. By the successive use of the second derivative of the intensity of image array elements which, in each case, are in neighboring locations of structured image areas, the proportion of lower spatial frequencies is reduced and the proportion of higher spatial frequencies is more heavily weighted. This type of filtering renders the edges of objects sharper, so that the image resolution is virtually increased, and correspondingly the optical image resolution is virtually improved. In order to achieve the greatest possible improvement in the image quality, a further development of the present invention provides that the filter parameters of the high-pass filter are set as a function of the resolution of the detector equipment. Yet another development of the method in accordance with the present invention includes controlling the intensity of the high-pass filtering as a function of each calculated normalized-value gradient so that, for example, the intensity of the high-pass filtering reduces in the transition zones between structured image areas and those with a homogenous appearance.

In terms of device technology, the object stated above is achieved by a device which serves to perform the method in accordance with the present invention, with parts for recording, storing and processing images, wherein a sequence of temporally successive individual images can be used to generate and put into temporary storage a resultant image produced by temporal averaging of the individual images, such that during a classificatory method step it is possible to identify structured areas of an image, and in a subsequent method step it is possible to apply high-pass filtering within the identified structured image areas of the resultant image. In doing this, local changes in the intensity between image array elements which are neighboring in the arrangement, in each case as determined by their position coordinates, can be successively calculated for the purposes of identifying the structured image areas in an image and, if a local change reaches or exceeds a predefined threshold parameter, the image array elements which underlie this change can be assigned to a structured image area. Because the detector noise is reduced as a result of the temporal averaging, and the resolution in the image areas which have been identified as structured is virtually increased by the high-pass filtering, there are diverse application areas for the device in accordance with the present invention.

The object stated above is further achieved by a computer program product in which the method in accordance with the present invention is implemented. The computer program product in accordance with the present invention may, for example, take the form of a machine code program, which would thus demand a relatively small storage capacity.

Additional features and advantages of the present invention are described in, and will be apparent from, the following Detailed Description of the Invention.

### DETAILED DESCRIPTION OF THE INVENTION

In the case of mobile terminal devices with video camera functions, images or sequences of images are recorded via a recording lens and are mapped on a detector device, which is frequently in the form of a CCD (Charge-Coupled Device) array. This detector device serves to convert the optical data which it receives into electrical signals, which are converted into digital data by a processor device preceded by an analog to digital converter. The digital data thus obtained is displayed on a display device which is downstream of the processor device, and which may take the form of a miniature TFT display or an LCD display. Devices of this type are either pure video cameras or mobile terminal devices which can take the form of mobile telephones with supplementary video camera functions. Particularly in the case of mobile telephones (so-called “mobiles”) incorporating supplementary video camera functions (so-called “video mobiles”), use is often made, because of financial considerations, of detectors or detector arrays which, although they are a good value, exhibit a relatively high noise level whereby the color and gray values of the images they supply show large temporal fluctuations which reduce the image quality. In addition, detectors of this type typically have a resolving capability of 352×288 pixels or image array elements, corresponding to the CIF standard (“Common Intermediate Format”) image format, so that because of the relatively low resolution there are coarse sampling effects, in particular in the representation of high-contrast object structures.

This is where the method in accordance with the present invention now begins, with an initial preparatory method step in which movement compensation is applied for each separate sequence of several individual images. A prerequisite for this is that the difference between the images in a sequence is only a minor translational or rotational one, where such differences can arise due to shaking movements of the person operating the device when holding it with an unsupported hand. In order to effect a movement of the individual images in the range of a few pixels down to sub-pixel positions, the source images are interpolated up two- to four-fold, so that they have instead of the 352×288 pixel elements of the detector, corresponding to the CIF format, either 704×576 or 1408×1152 pixel elements. After this, temporal averaging is used to produce from the sequence of movement-compensated individual images a resultant image, with this resultant image initially being stored temporarily. A consequence of this temporal averaging is a reduction in the noise in the resultant image, compared to the underlying individual or source images. To effect this, image array elements are selected for each individual image in a sequence, each element corresponding to location coordinates (x, y) in a coordinate system which defines the image array for each individual image, and for each of these the associated intensity is summed and divided by the number n of the individual images which belong to the sequence. The resulting intensity in each case is then the temporally averaged intensity for the image array element which corresponds to it in the image array of the temporarily stored resultant image. The intensity of an image array element is then, in each case, the electrical field strength measured at the location of the detector device, and includes both gray values and color values. A prerequisite for the use of the method in accordance with the present invention is that the detector noise follows a Gaussian distribution; i.e., the intensity of the detector noise as a function of time follows a Gaussian bell-shaped curve.

A method step which then follows carries out a classification procedure, which identifies and distinguishes structured areas from relatively unstructured areas in the image which has been temporarily stored. To effect this, successive calculations are made to determine local changes in the intensity between image array elements within the temporarily stored resultant image which, according to their location coordinates, are neighbors in the array. In practice, this is achieved by calculating the gradients (i.e., the first derivatives with respect to the spatial variables), between immediately adjacent image array elements or pixels and in each case forming their positive definite values. Furthermore, these gradient values are normalized by searching for the maximum of all the calculated gradient values within the image array and setting this to 1, so that the gradient values normalized in this way lie within a range of 0 to 1. In areas of the image with little structure (i.e., with a relatively homogeneous appearance), which are defined by relatively uniform gray and color values, such as in images of blue-sky, the gradient values determined for these represent only small changes, and hence lie close to zero. For the structured areas of the image, which might, for example, include the edges of buildings or suchlike, the gradient values determined assume higher values, which tend towards the highest value of 1, which makes it possible to distinguish and identify structured areas of an image from unstructured ones. In the exemplary embodiment, a threshold parameter is defined for this purpose, with a value which lies somewhere intermediate between the interval limits of 0 and 1, with each of the gradient values calculated on the basis of the image array concerned being compared with this threshold parameter. If this comparison shows that the gradient value concerned is as great as or exceeds this threshold value, then the associated image array elements are assigned to a structured area of the image array. On the other hand, the associated image array element is assigned to an unstructured image area if the gradient value concerned is less than this threshold parameter.

In the image areas of the image array which have been identified by the classification procedure as structured, a further method step carries out high-pass filtering. For this purpose, a second order filter is used as the high-pass filter, whereby in the exemplary embodiment a so-called Laplace filter has shown itself to be particularly efficient. The Laplace filter is an operator which, applied in each case to neighboring image matrix elements in the underlying image matrix, forms in each case a second derivative of the assigned intensities locally with respect to the spatial variables. The filter parameters of this high-pass filter are adapted for the resolution of the detector device which is being used. As a result, the structured areas of the image(e.g., the edges of buildings), are more clearly visible, and the noise is reduced, so that there is virtually a higher resolution by comparison with the original image. The high-pass filtering can be locally controlled via the gradient values which have been calculated so that the weight of the high-pass filtering is greatest in the center of an image area which has been identified as structured, and falls off in its edge zones, so that edge effects are amplified and the effect of the high-pass filtering disappears in the unstructured or homogeneous areas of the image. Using each of the calculated local gradient values, a derived weighting function can be defined, which can be used to determine the relative weights of the various method steps, of temporal averaging and high-pass filtering, and indeed as a function of the nature and scope of the structured or unstructured image areas present in the image concerned.

The device which is intended to carry out the method in accordance with the present invention has a recording lens and a detector device, where the recording lens serves to map the objects which are to be recorded onto the detector device. Further, the device includes, as already explained above, an analog-digital conversion device for converting the electrical image signals provided by the detector device, a processor device downstream from the analog-digital conversion device, together with a display device. A storage device which is electrically connected to the processor device serves to hold memory-resident program code with the method steps in accordance with the present invention. When operated in accordance with the requirements, the processor device accesses this program code and thus automatically carries out the method steps in accordance with the present invention, so that each of the final images calculated and filtered in accordance with the present invention is shown on the display device. In one possible application, the device in accordance with the present invention can take the form of a mobile telephone device with supplementary video functions.

The individual method steps, including the movement compensation, image classification and high-pass filtering, are carried out on source images which have been two- or four-fold interpolated. The images processed after this then have 704×576 or 1408×1152 pixel elements, instead of the 352×288 pixel elements of the CIF format. In this process, in each of the images which has been interpolated, any missing gray value is calculated on the basis of the gray values of each pixel element which in the source image is adjacent to the missing value, using bilinear interpolation. The method in accordance with the present invention, for processing each sequence of images, makes it possible to achieve an improvement in the image quality with respect to edge resolution and noise suppression where the images in each sequence, although they each show the same overall image, nevertheless may be displaced relative to each other by a few pixel or sub-pixel positions.

In summary, it should be emphasized that the method in accordance with the present invention carries out a temporal averaging for the purpose of reducing the detector noise, and permits each of the images which is to be processed to be classified into structured and low-structure image areas by the determination of local gradients, where the high-pass filtering is restricted to the image areas recognized as being structured, and thereby the resolution is virtually increased. An example of an application area is the recognition of text items with abrupt transitions in brightness between the text and the background. In another application area, it is possible to generate panoramic images by putting together a sequence of successive images recorded using a rotating movement.

Although the present invention has been described with reference to specific embodiment, those of skill in the art will recognize that changes may be made thereto without departing from the spirit and scope of the present invention as set forth in the hereafter appended claims.

1-13. (canceled)

14. A method for processing images sampled by at least one detector device, comprising:
generating a resultant image from a sequence of temporally successive individual images by temporal averaging of the individual images;
identifying structured areas of the resultant image; and
applying high-pass filtering in the identified structured areas of the resultant image.

15. A method for processing images as claimed in claim 14, wherein for image array elements which correspond with each other, as determined by respective location coordinates, in the sequence of temporally successive individual images, associated intensities are summed and each sum is divided by a number of individual images in the sequence.

16. A method for processing images as claimed in claim 14, wherein the step of identifying includes performing successive calculations of local changes in intensity between image array elements which, according to respective location coordinates, are adjacent, and that for each local change in intensity which at least reaches a predefined threshold parameter, the image array elements underlying a respective local change in intensity are assigned to a structured area.

17. A method for processing images as claimed in claim 16, wherein for local changes in the intensity which fall below the predefined threshold parameter, the image array elements underlying the respective local change in intensity are assigned to a low-structure area of the resultant image.

18. A method for processing images as claimed in claim 16, wherein local gradients are respectively calculated for purposes of determining the local change in intensity.

19. A method for processing images as claimed in claim 18, wherein each calculated local gradient has a value normalization applied.

20. A method for processing images as claimed in claim 14, wherein a second-order high-pass filter is used for purposes of the high-pass filtering.

21. A method for processing images as claimed in claim 20, wherein the high-pass filter serves as a Laplace operator, with the Laplace operator forming a second derivative with respect to the location variables.

22. A method for processing images as claimed in claim 20, wherein filter parameters of the high-pass filter are set as a function of a resolution of the detector device.

23. A method for processing images as claimed in claim 19, wherein intensity of the high-pass filtering is controlled as a function of the respective calculated normalized-value gradient.

24. A device for processing images, comprising:
at least one detector device for sampling the images;
a processor for generating a resultant image from a sequence of temporally successive individual images by temporal averaging of the individual images; and
a storage area for temporarily storing the resultant image;
wherein structured areas of the resultant image are identified, and high-pass filtering is applied in the identified structured areas of the resultant image.

25. A device for processing images as claimed in claim 24, wherein for purposes of identifying the structured image areas in the resultant image, local changes are calculated between intensities of image array elements which are respectively adjacent according to respective location coordinates, and for any local change which at least reaches a predefined threshold value the image array elements which underlie the respective local change are assigned to a structured area.

26. A computer program product for implementing a method for processing images sampled by at least one detector device, comprising:
a program step for effecting generation of a resultant image from a sequence of temporally successive individual images by temporal averaging of the individual images;
a program step for effecting identification of structured areas of the resultant image; and
a program step for effecting application of high-pass filtering in the identified structured areas of the resultant image.

27. A computer program product as claimed in claim 26, wherein the program step for effecting identification of the structured areas of the resultant image includes effecting calculations of location changes between intensities of image array elements which are respectively adjacent according to respective location coordinates, and for any local change which at least reaches a predefined threshold value, for effecting assignment of the image array elements which underlie the respective local change to a structured area.
